(19) United States
(12) Patent Application Publication
(10) Pub. No.: US 2009/0211388 A1
(43) Pub. Date: Aug. 27, 2009

(54) PULL-PULL TYPE SHIFTER CONTROL CABLE

(76) Inventors: Patrick Eugene Meysenburg, Urbandale, IA (US); Kent Birt, Hannibal, MO (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/035,178

(22) Filed: Feb. 21, 2008

(51) Int. Cl. F16C 1/10; G05G 9/00

(52) U.S. Cl. 74/473.15

(57) ABSTRACT

A shifter assembly includes a base and a shifter lever pivotably connected to the base so that the shifter lever is pivotable over a shift path about a laterally extending pivot axis. A shifter control cable assembly includes a first conduit, a first core disposed in the first conduit for longitudinal movement therein, a second conduit, and a second core disposed in the second conduit for longitudinal movement therein. The first core is operatively connected to the shifter lever so that the first core is pulled by the shifter lever when the shifter lever is pivoted about the pivot axis in a first direction. The second core is operatively connected to the shifter lever so that the second core is pulled by the shifter lever when the shifter lever is pivoted about the pivot axis in a second direction opposite the first direction.

### CROSS-REFERENCE TO RELATED APPLICATIONS

Not Applicable

### STATEMENT REGARDING FEDERALLY SPONSORED RESEARCH

Not Applicable

### REFERENCE TO MICROFICHE APPENDIX

Not Applicable

### FIELD OF THE INVENTION

The field of the invention generally relates to control cables and, more specifically, relates to control cables for shifters.

### BACKGROUND OF THE INVENTION

Motion-transmitting control cable assemblies, sometimes referred to as “Bowden cables”, are used for transmitting both force and travel along a path. Use of such cable assemblies can be found in aircraft, automotive, and marine environments. A control cable assembly typically includes a flexible core element slidably enclosed within a flexible outer sheath. The core element may be adapted at one end to be attached to a member to be controlled whereas the other end may be attached to an actuator for longitudinally moving the core element within the outer sheath. The outer sheath is secured by some type of anchor, such as by coupling end fittings to stationary support structures, brackets, abutment members, or the like.

One example of a specific use of such control cable assemblies is changing gears of a transmission in motor vehicles. Typically, a shifter lever is pivotable over a series of positions representative of desired transmission gears. For example, a motor vehicle equipped with an automatic transmission, can have transmission gears of park (P), reverse (R), neutral (N), drive (D), and low gear (M). The shifter lever is connected to the motor vehicle transmission by a push-pull control cable assembly to effect actuation of the transmission to the selected gear when the shifter lever is moved to the gear's representative position. When the shifter lever is pivoted in a first direction, the cable pulls the core element to pivot the transmission lever in a first direction. When the shifter lever is pivoted in a second or opposite direction, the cable pushes the core element to pivot the transmission lever in a second or opposite direction.

These shifter control cable assemblies must be manufactured to very close tolerances to meet performance requirements. In the motor vehicle industry, there is a never ending desire to reduce weight and cost while maintaining vigorous performance requirements and improving reliability. Accordingly, there is a need in the art for improved shifter control cable assemblies where more light duty construction meets the performance requirements.

### SUMMARY OF THE INVENTION

Disclosed herein is a shifter assembly and a shifter control cable system which addresses one or more issues in the related art. According to one embodiment there is disclosed herein a shifter assembly and control cable assembly for a motor vehicle in combination. The shifter assembly comprises a base and a shifter lever pivotably connected to the base so that the shifter lever is pivotable over a shift path about a laterally extending pivot axis. The shifter control cable assembly comprises a first conduit, a first core disposed in the first conduit for longitudinal movement therein, a second conduit, and a second core disposed in the second conduit for longitudinal movement therein. The first core is operatively connected to the shifter lever so that the first core is pulled by the shifter lever when the shifter lever is pivoted about the pivot axis in a first direction and the second core is operatively connected to the shifter lever so that the second core is pulled by the shifter lever when the shifter lever is pivoted about the pivot axis in a second direction opposite the first direction.

According to another embodiment there is disclosed herein a shifter assembly and control cable assembly for a motor vehicle in combination. The shifter assembly comprises a base and a shifter lever pivotably connected to the base so that the shifter lever is pivotable over a shift path about a laterally extending pivot axis. The shifter control cable assembly comprises a first conduit, a first core disposed in the first conduit for longitudinal movement therein, a second conduit, and a second core disposed in the second conduit for longitudinal movement therein. The first core is operatively connected to the shifter lever so that the first core is pulled by the shifter lever when the shifter lever is pivoted about the pivot axis in a first direction. The second core is operatively connected to the shifter lever so that the second core is pulled by the shifter lever when the shifter lever is pivoted about the pivot axis in a second direction opposite the first direction. A first end of the first conduit is secured to a rearward end of the base so that the first core forwardly extends from the rearward end of the base to a first attachment location on the shifter lever. A first end of the second conduit is secured to the rearward end of the base so that the second core forwardly extends from the rearward end of the base to a second attachment location of the shifter lever. The pivot axis of the shifter lever is located between the first attachment location and the second attachment location. A retention mount secures both the first end of the first conduit and the first end of the second conduit to the rearward end of the base. A second end of the first core is secured to an actuated lever pivotable about a pivot axis so that the first core pivots the actuated lever about the pivot axis of the actuated lever in a first direction when the shifter lever pulls the first core. A second end of the second core is operatively connected to the actuated lever so that the second core pivots the actuated lever about the pivot axis of the actuated lever in a second direction opposite the first direction when the shifter lever pulls the second core.

According to yet another embodiment there is disclosed herein a shifter assembly and control cable assembly for a motor vehicle in combination. The shifter assembly comprises a base and a shifter lever pivotably connected to the base so that the shifter lever is pivotable over a shift path about a laterally extending pivot axis. The shifter control cable assembly comprises a first conduit, a first core disposed in the first conduit for longitudinal movement therein, a second conduit, and a second core disposed in the second conduit for longitudinal movement therein. The first core is operatively connected to the shifter lever so that the first core is pulled by the shifter lever when the shifter lever is pivoted about the pivot axis in a first direction. The second core is operatively connected to the shifter lever so that the second core is pulled by the shifter lever when the shifter lever is pivoted about the pivot axis in a second direction opposite the first direction. The first conduit has a first end secured to a rearward end of the base so that the first core forwardly extends from the rearward end of the base to the shifter lever. The second conduit has a first end secured to a forward end of the base opposite the rearward end of the base so that the second core rearwardly extends from the forward end of the base to the shifter lever. The first end of the first core and the first end of the second core are secured to a common attachment location of the shifter lever. A second end of the first core is secured to an actuated lever pivotable about a pivot axis so that the first core pivots the actuated lever about the pivot axis of the actuated lever in a first direction when the shifter lever pulls the first core. A second end of the second core is operatively connected to the actuated lever so that the second core pivots the actuated lever about the pivot axis of the actuated lever in a second direction opposite the first direction when the shifter lever pulls the second core.

According to yet another embodiment there is disclosed herein a shifter assembly and control cable assembly for a motor vehicle in combination. The shifter assembly comprises a base and a shifter lever pivotably connected to the base so that the shifter lever is pivotable over a shift path about a laterally extending pivot axis. The shifter control cable assembly comprises a first conduit, a first core disposed in the first conduit for longitudinal movement therein, a second conduit, and a second core disposed in the second conduit for longitudinal movement therein. The first core is operatively connected to the shifter lever so that the first core is pulled by the shifter lever when the shifter lever is pivoted about the pivot axis in a first direction. The second core is operatively connected to the shifter lever so that the second core is pulled by the shifter lever when the shifter lever is pivoted about the pivot axis in a second direction opposite the first direction. The first core and the second core are operatively connected to the shifter lever by a double rack and pinion mechanism. A first end of the first core is secured to a first rack which is operably connected to the shifter lever. A first end of the second core is secured to a second rack. A pinion is rotatably supported by the base in a fixed position and operably engages each of the racks so that the first rack and the first core secured thereto is pulled by the shifter lever when the shifter lever is pivoted about the pivot axis of the shifter lever in a first direction and so that the first rack is pushed to rotate the pinion and pull the second rack and the second core secured thereto when the shifter lever is pivoted about the pivot axis of the shifter lever in a second direction opposite the first direction. A second end of the first core is secured to an actuated lever pivotable about a pivot axis so that the first core pivots the actuated lever about the pivot axis of the actuated lever in a first direction when the shifter lever pulls the first core. A second end of the second core is operatively connected to the actuated lever so that the second core pivots the actuated lever about the pivot axis of the actuated lever in a second direction opposite the first direction when the shifter lever pulls the second core.

From the foregoing disclosure and the following more detailed description of various preferred embodiments it will be apparent to those skilled in the art that the present invention provides a significant advance in the technology of shifter control cable assemblies. Particularly, the invention(s) disclosed herein provides a relatively low weight and relatively low cost shifter assembly and control cable system. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a perspective view of a system according a first embodiment of the present invention;

FIG. 2 is an enlarged perspective view of an actuator end of a control cable assembly of the system of FIG. 1 with components removed for clarity;

FIG. 3 is a perspective view of a system according a second embodiment of the present invention;

FIG. 4 is an enlarged perspective view of an actuator end of the control cable assembly of the system of FIG. 3 with components removed for clarity;

FIG. 5 is a perspective view of a system according a third embodiment of the present invention;

FIG. 6 is an enlarged perspective view of an actuator end of a control cable assembly of the system of FIG. 5 with components removed for clarity;

FIG. 7 is an enlarged perspective view of an alternative actuated end of the control cable assemblies of the systems of FIGS. 1 to 6; and

FIG. 8 is a cross sectional view of the control cable assemblies of FIGS. 1 to 7.

It should be understood that the appended drawings are not necessarily to scale, presenting a somewhat simplified representation of various preferred features illustrative of the basic principles of the invention. The specific design features of the quick connecting device as disclosed herein, including, for example, specific dimensions, orientations, and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the remote control cable assemblies illustrated in the drawings. In general, up or upward refers to an upward direction generally in the plane of the paper in FIG. 1 and down or downward refers to a downward direction generally in the plane of the paper in FIG. 1. Also in general, fore or forward refers to a direction generally toward the left in the plane of the paper in FIGS. 1 and 13, that is toward the end of the cable core, and aft or rearward refers to a direction generally toward the right in the plane of the paper in FIGS. 1 and 13, that is away from the end of the cable core.

### DETAILED DESCRIPTION OF CERTAIN PREFERRED EMBODIMENTS

The following detailed discussion of various alternative and preferred embodiments will illustrate the general principles of the invention with reference to motion control devices for use with a motor vehicle transmission system. Other embodiments suitable for other motion control devices will be apparent to those skilled in the art given the benefit of this disclosure.

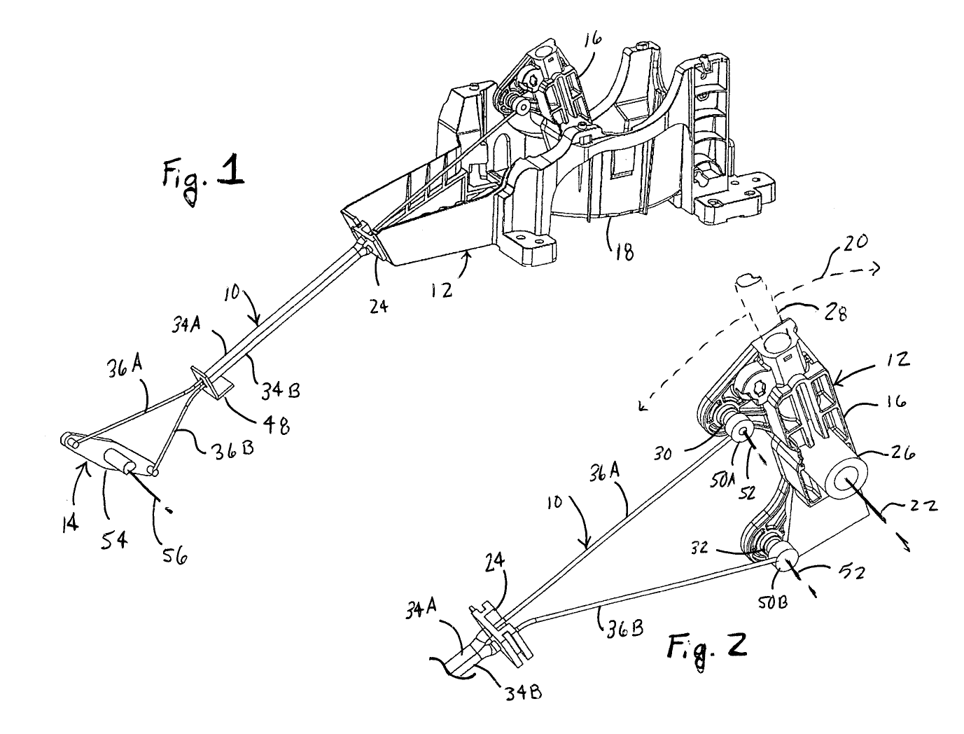

Referring now to the drawings, FIGS. 1 and 2 show an actuation system for a motor vehicle, such as an automobile, according to a first illustrated embodiment of the present invention. While the illustrated embodiments of the present invention are particularly adapted for use with an automobile, it is noted that the present invention can be utilized with any motor vehicle having a control cable assembly including trucks, buses, vans, recreational vehicles, earth moving equipment and the like, off road vehicles such as dune buggies and the like, air borne vehicles, and water borne vehicles. While the illustrated embodiments of the present invention are particularly adapted for use with a transmission system, it is also noted that the present invention can be utilized with other motor vehicle systems such as, for example, a transfer case, a parking brake, accelerator, hood release, brake release, trunk release, park lock, tilt wheel control, fuel filler door, and/or hydraulic control cables.

The illustrated actuation system includes a control cable assembly 10 which connects an actuator such as the illustrated shifter assembly 12 to an actuated device such as the illustrated transmission assembly 14. The illustrated shifter assembly 12 includes an actuator or shifter lever 16 pivotably connected to a base or mounting bracket 18 so that the shifter lever 16 is pivotable over a shift path 20 about a laterally extending a pivot axis 22. The illustrated base longitudinally extends from a first or rearward end to a second or forward end. The pivot axis is substantially perpendicular to the shift path and the central longitudinal axis extending between the forward and rearward ends. The illustrated rearward end is adapted to receive an end fitting or retention mount 24 of the control cable assembly 10 is as described in hereinafter. The illustrated shifter lever 16 has a hub portion 26 for receiving a pin or axle forming the pivot axis 22 and an upwardly extending lever portion 28 for receiving a manual force from the operator pivot the shifter lever 16 in a forward and rearward direction about the pivot axis 22. The illustrated shifter lever 16 is provided with first and second attachment points or locations 30, 32 for securing the control cable assembly 10 to the shifter lever 16 as described in more detail hereinafter. The first and second attachment locations 30, 32 are located on opposite sides of the pivot axis 22. The illustrated first pivot attachment 30 is located above the pivot axis 22 while the illustrated second pivot attachment is located below the pivot axis 22.

As shown in FIG. 8, the illustrated control cable assembly 10 includes first and second flexible outer sheaths or conduits 34A, 34B and first and second flexible inner cores or strands 36A, 36B longitudinally slidable or movable within the conduits 34A, 34B. In automotive applications, each conduit 34A, 34B typically includes an interior thermoplastic tube or liner 38A, 38B. The liner 38A, 38B forms the inside diameter or passage 39A, 39B of the conduit 34A, 34B. It is noted that the liner 38A, 38B can alternatively be eliminated if desired depending on performance requirements. Exterior to the liner 38A, 38B, a reinforcing element 40A, 40B, such as a plurality of metal wires helically wrapped about the liner 38A, 38B, is provided to add strength to the thermoplastic liner 38A, 38B. The reinforcing element 40A, 40B gives added strength for the compression and tension loads applied during operation. The illustrated reinforcing element 40A, 40B is a spaced-wire system including twelve wires or wire bundles spaced apart to form gaps therebetween. It is noted that other suitable quantities of wires or wire bundles can alternatively be utilized depending on the specific application. For example, there can be additional wires to obtain a full-wire system wherein the wires or wire bundles fully surround the liner 38A, 38B with no gaps therebetween or fewer wires such as three wires. After the reinforcing element 40A, 40B is applied about the liner 38A, 38B, an outer coating or jacket 42A, 42B of flexible thermoplastic material is applied to hold the reinforcing element 40A, 40B in relation to the liner 38A, 38B and fully encapsulate the sub-assembly. The outer coating 42A, 42B is typically applied through a high temperature extrusion process. Through extrusion, an outside diameter is formed around the sub-assembly and the conduit 34A, 34B can be cut to a desired length. It is noted that the conduit 34A, 34B can alternatively utilize any other suitable materials and/or can alternatively have any other suitable construction within the scope of the present invention.

The first and second conduits 34A, 34B are secured together by forming or extruding them together as a unitary one-piece component over at least a portion of their length. The illustrated conduits 34A, 34B are formed with contiguous and joined outer coatings 42A, 42B so that the first conduit 34A is located above the second conduit 34B. It is noted that alternatively the first and second conduits 34A, 34B can be secured together in other suitable manners or can alternatively remain as separate components.

Each core 36A, 36B typically consists of a strand assembly made up of metal wires. The metal wires are wound in different configurations depending upon the application. The illustrated core 36A, 36B has a center wire or wire bundle 44A, 44B. To strengthen the center wire 44A, 44B, a reinforcing element 46A, 46B is provided such as, for example, a plurality of outer wires or wire bundles, helically wound around the center wire 44A, 44B. As with the reinforcing element 40A, 40B for the conduit liner 38A, 38B, the reinforcing element 46A, 46B for the core 36A, 36B provides support for the center wire 44A, 44B. The illustrated reinforcing element 46A, 46B is a full-wire system including six wires or wire bundles that fully surround the center wire 44A, 44B with no gaps therebetween. It is noted that other suitable quantities of wires or wire bundles can alternatively be utilized. It is also noted that a spaced-wire system can be alternatively utilized wherein the wires or wire bundles are spaced apart to form gaps therebetween. It is noted that the core 36A, 36B can alternatively utilize any other suitable materials and/or can alternatively have any other suitable construction within the scope of the present invention.

As shown in FIGS. 1 and 2, first ends of the illustrated conduits 34A, 34B are secured to the fixed-position retention mount or abutment member 24 which is in turn secured to the first or rearward end of the base 18 so the first ends of conduits 34A, 34B are maintained in a fixed position relative to the base 18. The first ends of the conduits 34A, 34B abut the retention mount 24 to prevent longitudinal movement of the first ends of the conduits 34A, 34B. The conduits 34A, 34B can be secured to the retention mount 24 in any suitable manner such as for example, a press fit, adhesive, mechanical fastener, or the like. The illustrated retention mount 24 is sized and shaped to be slidably received by the base 18 in generally the vertical direction so that the retention mount 24 is removably secured to the base 18. It is noted that the retention mount 24 can alternatively be secured to the base 18 in any other suitable manner.

Second ends of the illustrated conduits 34A, 34B are secured to a fixed-position mounting bracket or abutment member 48 which is in turn secured to the transmission assembly 14 so the second ends of conduits 34A, 34B are maintained in a fixed position relative to the transmission assembly 14. The second ends of the conduits 34A, 34B abut the mounting bracket 48 to prevent longitudinal movement of the second ends of the conduits 34A, 34B. The conduits 34A, 34B can be secured to the mounting bracket 48 in any suitable manner such as for example, a press fit, adhesive, mechanical fastener, or the like. The mounting bracket 48 is secured to the base 18 in any suitable manner.

The illustrated first core 36A is operatively connected to the shifter lever 16 so that the first core 36A is pulled by the shifter lever 16 when the shifter lever 16 is pivoted about the pivot axis 22 in a first or forward direction. Because the first end of the first conduit 34A is secured to the rearward end of the base 18 and facing the shifter lever 16, the first core 36A forwardly extends from the rearward end of the base 18 to the shifter lever 16. The first end of the first core 36A is secured to the first attachment location 30 of the shifter lever 16. The first end of the first core 36A is provided with an end fitting 50A which cooperates with the shifter lever 16 to form a pivoting joint therebetween so that the end fitting 50A can pivot about a laterally extending pivot axis 52 as the first attachment location 30 moves over an arc shaped path as the shifter lever 16 pivots about its pivot axis 22. The pivoting joint can be of any suitable type such as, for example, a pin and socket joint or the like. It is noted that the pivoting joint may alternatively be eliminated if not needed by the operating conditions such as the arc length, arc radius etc.

The illustrated second core 36B is operatively connected to the shifter lever 16 so that the second core 36B is pulled by the shifter lever 16 when the shifter lever 16 is pivoted about the pivot axis 22 in a second or rearward direction which is opposite the first or forward direction. Because the first end of the second conduit 34B is secured to the rearward end of the base 18 and facing the shifter lever 16, the second core forwardly extends from the rearward end of the base 18 to the shifter lever 16. The first end of the second core 36B is secured to the second attachment location 32 of the shifter lever 16. The first end of the second core 36B is provided with an end fitting 50B which cooperates with the shifter lever 16 to form a pivoting joint therebetween so that the end fitting 50B can pivot about a laterally extending pivot axis 52 as the second attachment location 32 moves over an arc shaped path as the shifter lever 16 pivots about its pivot axis 22. The pivoting joint can be of any suitable type such as, for example, a pin and socket joint or the like. It is noted that the pivoting joint may alternatively be eliminated if not needed by the operating conditions such as the arc length, arc radius etc.

The illustrated first core 36A is also operatively connected to an actuated lever 54 of the transmission assembly 14 so that the first core 36A pulls the actuated lever 54 in a first or forward direction to pivot the actuated lever 54 about a pivot axis 56 in a first direction when the first core 36A is pulled by the shifter lever 16 when the shifter lever 16 is pivoted about the pivot axis 22 in the first or forward direction. The second end of the first core 36A is secured to a first or upper end of the actuated lever 54 by any suitable means. If desired, a pivoting joint can be provided for the second end of the first core 36A as discussed above with reference to the first end of the first core 36A.

The illustrated second core 36B is also operatively connected to the actuated lever 54 of the transmission assembly 14 so that the second core 36B pulls the actuated lever 54 in the first or forward direction to pivot the actuated lever 54 about the pivot axis 56 in a second direction opposite the first direction when the second core 36B is pulled by the shifter lever 16 when the shifter lever 16 is pivoted about the pivot axis 22 in the second or rearward direction. The second end of the second core 36B is secured to a second or end of the actuated lever 54 by any suitable means. The second or lower end of the actuated lever 54 is located on an end opposite the first or upper end with the pivot axis 56 located therebetween. If desired, a pivoting joint can be provided for the second end of the second core 36B as discussed above with reference to the first end of the second core 36B.

Because the second ends of the first and second conduits 34A, 34B are secured to the common mounting bracket 48 and face the shifter lever 16, the first and second cores 36A each extend in the same direction from the conduits 34A, 34B to the actuated lever 54. Because the common mounting bracket 48 located on a forward side of the actuated lever 54, the first and second cores 36A each rearwardly extend from the conduits 34A, 34B to the actuated lever 54. It is noted that while the conduits 34A, 34B are illustrated as extending linearly between the retention mount 24 and the mounting bracket 48, the conduits 34A, 34B can be routed in any desired path allowed by the flexibility of the conduits 34A, 34B and the cores 36A, 36B therein.

In operation, the vehicle operator manually moves the shifter lever 16 along the shift path 20 to a desired gear position. When the operator pivots the shifter lever 16 in the first or forward direction, the shifter lever 16 pulls the first core 36A which pulls the upper end of the actuated lever 54 to pivot the actuated lever 54 in the first direction. When the operator pivots the shifter lever 16 in the second or rearward direction, the shifter lever 16 pulls the second core 36B which pulls the lower end of the actuated lever 54 to pivot the actuated lever 54 in the second direction. The pivoting motion of the actuated lever 54 in either direction moves the transmission assembly 14 to the desired gear. Thus, the actuated lever 54 is pulled in each direction by one of the cores 36A, 36B.

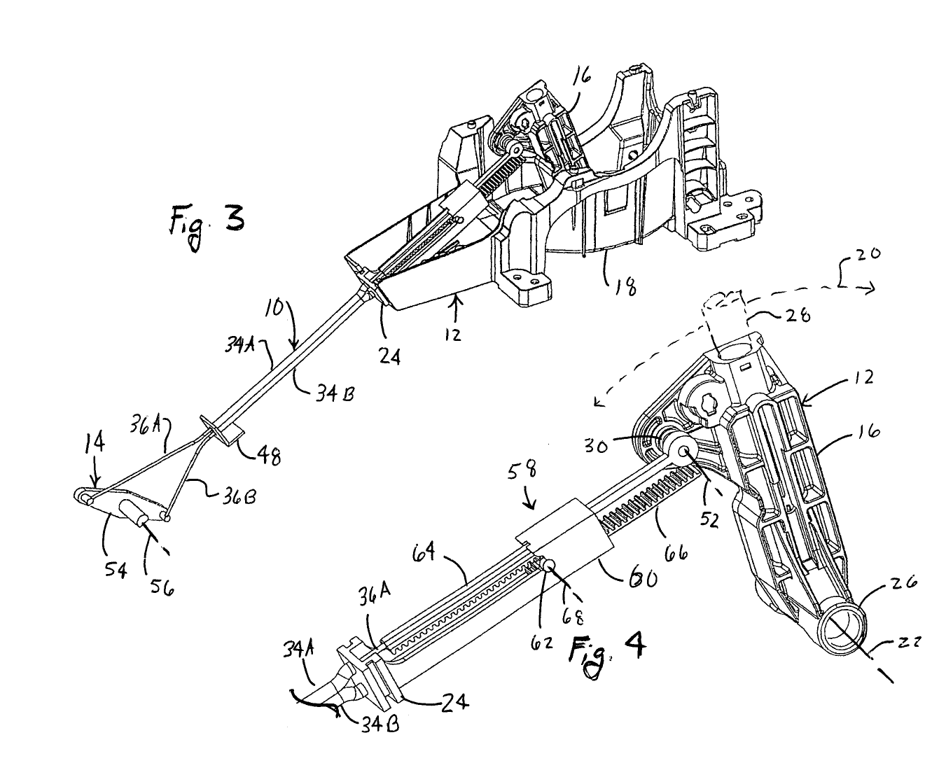

FIGS. 3 and 4 illustrate system according to a second illustrated embodiment of the present invention wherein like reference numbers are utilized to show like structure. The system according to the second embodiment is substantially the same as the system according to the first embodiment described hereinabove except that the first and second cores 36A, 36B are secured to the shifter lever 16 with a double rack and pinion mechanism 58.

The illustrated double rack and pinion mechanism 58 includes a stationary housing 60, a pinion gear 62 rotatably supported by the housing 60, and first and second racks 64, 66 engaging opposite sides of the pinion gear 62 so that rotation of the pinion gear 62 linearly moves the racks 64, 66 in opposite directions. The illustrated housing 60 forwardly extends from the retention mount 24 to secure the housing to the base 18 against relative movement therebetween. The illustrated housing 60 is formed as a unitary one piece component with the retention mount 24 but can alternatively be formed as a separate component secured to the retention mount or secured directly to the base 18. The illustrated pinion gear 62 includes a plurality of teeth and is rotationally supported between opposed lateral walls of the housing 60 so that the pinion gear is rotatable about a laterally extending pivot axis 68. The first rack 64 extends in the forward-rearward direction above the pinion gear 62 and has a row of downwardly facing teeth which operably engage the teeth of the pinion gear 62. The second rack 66 extends in the forward-rearward direction below the pinion gear 62 and has a row of upwardly facing teeth which operably engage the teeth of the pinion gear 62.

The first end of the first core 36A is secured to a rearward end of the first rack 64. A forward end of the first rack 64 is operably connected to the shifter lever 16 at the first attachment location 30. The first rack 64 is preferably secured to the shifter lever 16 by a pivot joint as described hereinabove with regard to the first embodiment. The first end of the second core 36B is secured to a rearward end of the second rack 66. The pinion gear 62 is rotatably supported in a fixed position and operably engages each of the racks 64, 66 so that the first rack 64, and the first core 36A secured thereto, is pulled by the shifter lever 16 when the shifter lever 16 is pivoted about the pivot axis 22 in the first or forward direction and so that the first rack 64 is pushed to rotate the pinion gear 62 and pull the second rack 66, and the second core 36B secured thereto, when the shifter lever 16 is pivoted about the pivot axis 22 in the second or rearward direction opposite the first direction.

In operation, the vehicle operator manually moves the shifter lever 16 along the shift path 20 to a desired gear position. When the operator pivots the shifter lever 16 in the first or forward direction, the shifter lever 16 pulls the first rack 64, and the first core 36A attached thereto, which pulls the upper end of the actuated lever 54 to pivot the actuated lever 54 in the first direction. When the operator pivots the shifter lever 16 in the second or rearward direction, the shifter lever 16 pushes the first rack 64 which rotates the pinion gear 62 and pulls the second rack 66, and the second core 36B secured thereto, which pulls the lower end of the actuated lever 54 to pivot the actuated lever 54 in the second direction. The pivoting motion of the actuated lever 54 in either direction moves the transmission assembly 14 to the desired gear. Thus, the actuated lever 54 is pulled in each direction by one of the cores 36A, 36B.

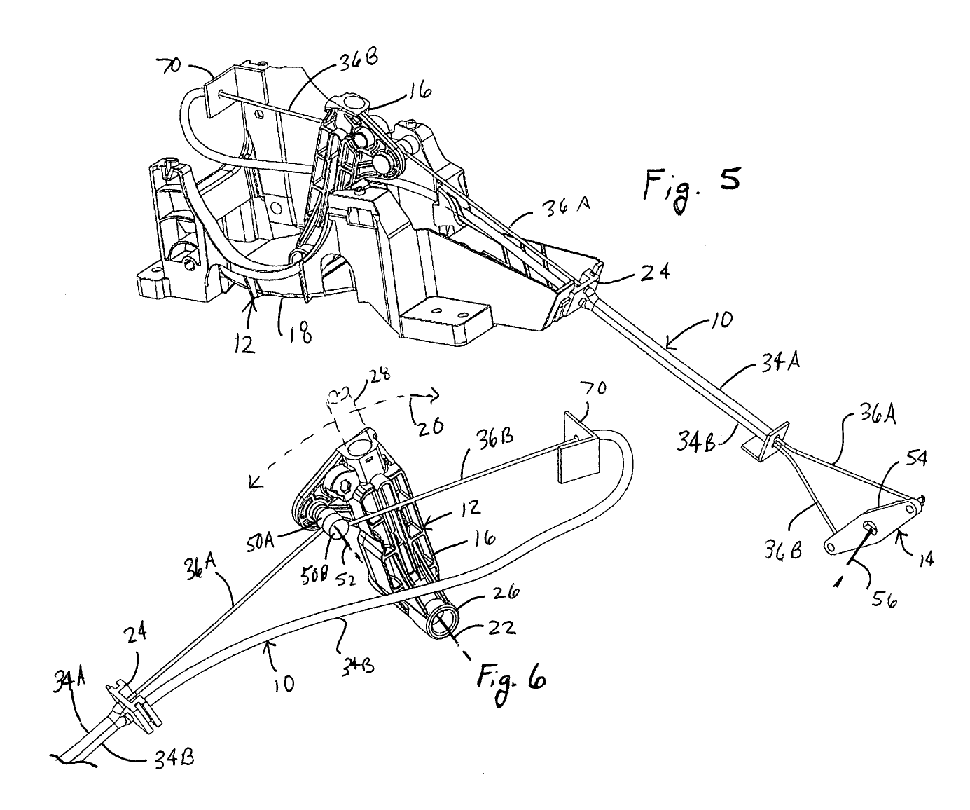

FIGS. 5 and 6 illustrate system according to a third illustrated embodiment of the present invention wherein like reference numbers are utilized to show like structure. The system according to the third embodiment is substantially the same as the system according to the first embodiment described hereinabove except that the first and second cores 36A, 36B are secured to the shifter lever 16 from different directions.

The second conduit 34B extends through the retention mount 24 to a fixed-position mounting bracket or abutment member 70 which is secured to a forward end of the base 18 so the first end of the conduit 34B is maintained in a fixed position relative to the base 18. The first end of the conduit 34B abuts the mounting bracket 70 to prevent longitudinal movement of the first end of the conduit 34B. The conduit 34B can be secured to the mounting bracket in any suitable manner such as for example, a press fit, adhesive, mechanical fastener, or the like. The mounting bracket 70 can be secured to the base 18 in any suitable manner.

The illustrated second core 36B is operatively connected to the shifter lever 16 so that the second core 36B is pulled by the shifter lever 16 when the shifter lever 16 is pivoted about the pivot axis 22 in the second or rearward direction which is opposite the first or forward direction. Because the first end of the second conduit 34B is secured to the forward end of the base 18 and facing the shifter lever 16, the second core 36B rearwardly extends from the forward end of the base 18 to the shifter lever 16. The first end of the second core 36B is secured to the first attachment location 30 of the shifter lever 16 along with the first end of the first core 36A so that the first ends of the cores 36A, 36B are secured at the same side of the pivot axis 22 at the common attachment location 30. The first end of the second core 36B is provided with an end fitting 50B which cooperates with end fitting 50A of the first core 36A and the shifter lever 16 to form a pivoting joint therebetween so that the end fitting 50B can pivot about the laterally extending pivot axis 52 as the attachment location 30 moves over an arc shaped path as the shifter lever 16 pivots about its pivot axis 22. The pivoting joint can be of any suitable type such as, for example, a pin and socket joint or the like. It is noted that the pivoting joint may alternatively be eliminated if not needed by the operating conditions such as the arc length, arc radius etc.

In operation, the vehicle operator manually moves the shifter lever 16 along the shift path 20 to a desired gear position. When the operator pivots the shifter lever 16 in the first or forward direction, the shifter lever 16 pulls the first core 36A which pulls the upper end of the actuated lever 54 to pivot the actuated lever 54 in the first direction. When the operator pivots the shifter lever 16 in the second or rearward direction, the shifter lever 16 pulls the second core 36B which pulls the lower end of the actuated lever 54 to pivot the actuated lever 54 in the second direction. The pivoting motion of the actuated lever 54 in either direction moves the transmission assembly 14 to the desired gear. Thus, the actuated lever 54 is pulled in each direction by one of the cores 36A, 36B.

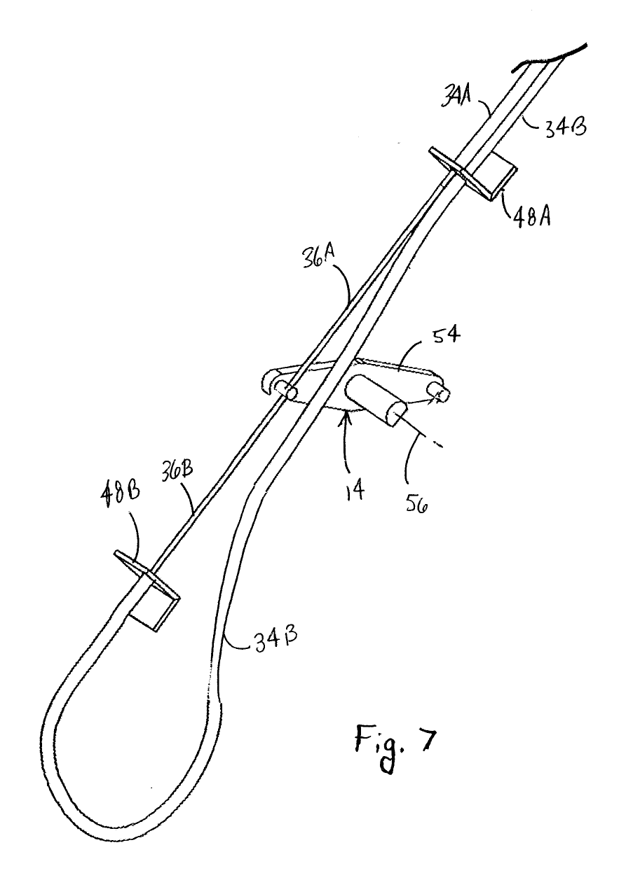

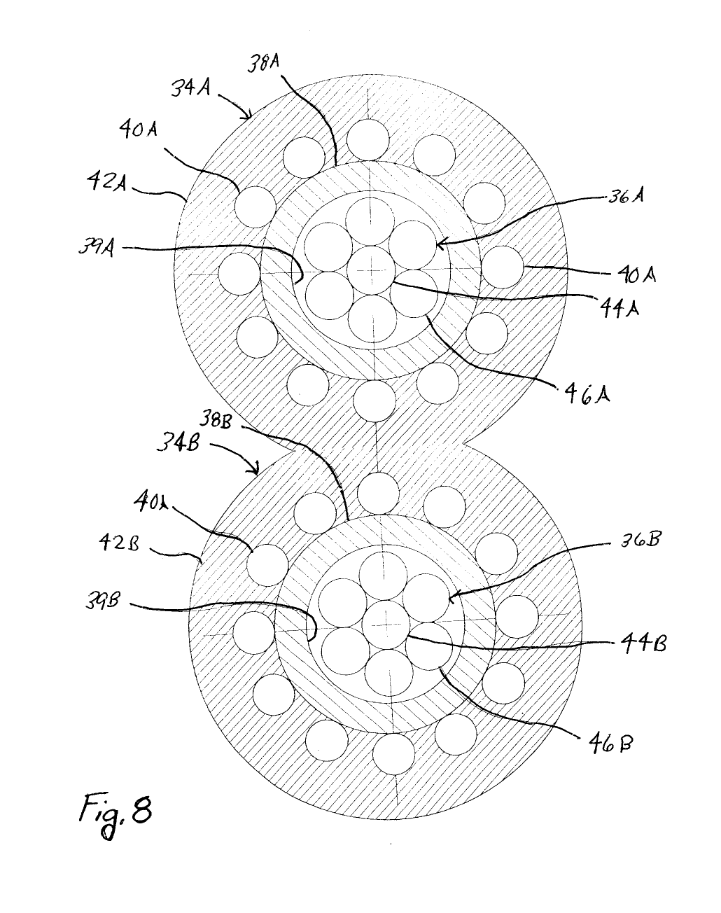

FIG. 7 illustrates a variation of the connection to actuated lever 54 which illustrates that the first and second cores 36A, 36B can be secured to the actuated lever 54 from different directions. Separate mounting brackets 48A, 48B for the second ends of the conduits 34A, 34B are provided on opposites sides of the actuated lever 54 with the pivot axis 56 located therebetween. With the second ends of the conduits 34A, 34B secured in this manner, the second ends of the cores 36A, 36B extend from the conduits 34A, 34B to the actuated lever in opposite directions and are secured to a common attachment location of the actuated lever 54. This variation of the connection can be utilized with any of the above described embodiments of the invention. It is also noted that any of the features of the various disclosed embodiments can be utilized with any of the other various disclosed embodiments within the scope of the present invention.

It is apparent from the foregoing disclosure present invention provides a pull-pull control cable assembly which can be constructed of smaller and/or relatively inexpensive materials compared to prior art push-pull control cable assemblies because cables are typically much stronger in tension. Additionally, components of prior art push-pull cable assemblies such as rod ends and swivel tubes. As a result the present invention provides improved shifter control cable assemblies with a more light duty construction that meets the performance requirements to reduce cost and/or weight.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A shifter assembly and control cable assembly for a motor vehicle comprising, in combination:
a shifter assembly comprising:
a base having a first end and a second end opposite the first end;
a shifter lever pivotably connected to the base so that the shifter lever is pivotable over a shift path about a laterally extending pivot axis;
a shifter control cable assembly comprising:
a first conduit having a first end and a second end;
a first core disposed in the first conduit for longitudinal movement therein and having a first end and a second end;
a second conduit having a first end and a second end;
a second core disposed in the second conduit for longitudinal movement therein and having a first end and a second end;
wherein the first core is operatively connected to the shifter lever so that the first core is pulled by the shifter lever when the shifter lever is pivoted about the pivot axis in a first direction and the second core is operatively connected to the shifter lever so that the second core is pulled by the shifter lever when the shifter lever is pivoted about the pivot axis in a second direction opposite the first direction.

2. The shifter assembly and control cable assembly of claim 1, wherein the first end of the first conduit is secured to the first end of the base so that the first core extends from the first end of the base to a first attachment location on the shifter lever, the first end of the second conduit is secured to the first end of the base so that the second core extends from the first end of the base to a second attachment location of the shifter lever, and the pivot axis of the shifter lever is located between the first attachment location and the second attachment location.

3. The shifter assembly and control cable assembly of claim 2, wherein the first end of the base is a rearward end of the base so that the first core forwardly extends from the rearward end of the base to the first attachment location on the shifter lever, and the second core forwardly extends from the rearward end of the base to the second attachment location of the shifter lever.

4. The shifter assembly and control cable assembly of claim 2, further comprising a retention mount securing both the first end of the first conduit and the first end of the second conduit to the first end of the base.

5. The shifter assembly and control cable assembly of claim 1, further comprising a retention mount securing both the first end of the first conduit and the first end of the second conduit to the base.

6. The shifter assembly and control cable assembly of claim 1, wherein the first end of the first conduit is secured to the first end of the base so that the first core extends from the first end of the base to the shifter lever, the first end of the second conduit is secured to the second end of the base so that the second core extends from the second end of the base to the shifter lever.

7. The shifter assembly and control cable assembly of claim 6, wherein the first core and the second core are secured to a common attachment location of the shifter lever.

8. The shifter assembly and control cable assembly of claim 6, wherein the first end of the base is a rearward end of the base so that the first core forwardly extends from the rearward end of the base to the shifter lever, and the second end of the base is a forward end of the base opposite so that the second core rearwardly extends from the forward end of the base to the shifter lever.

9. The shifter assembly and control cable assembly of claim 8, wherein the first core and the second core are secured to a common attachment location of the shifter lever.

10. The shifter assembly and control cable assembly of claim 1, wherein the first core and the second core are secured to a common attachment location of the shifter lever.

11. The shifter assembly and control cable assembly of claim 1, wherein the first core and the second core are operatively connected to the shifter lever by a double rack and pinion mechanism.

12. The shifter assembly and control cable assembly of claim 11, wherein the first core is secured to a first rack which is operably connected to the shifter lever, the second core is secured to a second rack, a pinion is rotatably supported in a fixed position and operably engages each of the racks so that the first rack and the first core secured thereto is pulled by the shifter lever when the shifter lever is pivoted about the pivot axis in a first direction and so that the first rack is pushed to rotate the pinion and pull the second rack and the second core secured thereto when the shifter lever is pivoted about the pivot axis in a second direction opposite the first direction.

13. The shifter assembly and control cable assembly of claim 1, wherein the second end of the first core is operatively connected to an actuated lever pivotable about a pivot axis so that the first core pivots the actuated lever about the pivot axis of the actuated lever in a first direction when the shifter lever pulls the first core and the second end of the second core is operatively connected to the actuated lever so that the second core pivots about the pivot axis of the actuated lever the actuated lever in a second direction opposite the first direction when the shifter lever pulls the second core.

14. The shifter assembly and control cable assembly of claim 13, wherein the first core is secured to a first attachment location of the actuated lever, the second core is secured to a second attachment location of the actuated lever, and the pivot axis of the actuated lever is located between the first attachment location and the second attachment location.

15. The shifter assembly and control cable assembly of claim 1, wherein the first and second conduits are secured together.

16. The shifter assembly and control cable assembly of claim 15, wherein the first and second conduits are formed as a unitary one-piece component.

17. A shifter assembly and control cable assembly for a motor vehicle comprising, in combination:
a shifter assembly comprising:
a base having a forward end and a rearward end opposite the forward end;
a shifter lever pivotably connected to the base so that the shifter lever is pivotable over a shift path about a laterally extending pivot axis;
a shifter control cable assembly comprising:
a first conduit having a first end and a second end;
a first core disposed in the first conduit for longitudinal movement therein and having a first end and a second end;
a second conduit having a first end and a second end;
a second core disposed in the second conduit for longitudinal movement therein and having a first end and a second end;
wherein the first end of the first core is operatively connected to the shifter lever so that the first core is pulled by the shifter lever when the shifter lever is pivoted about the pivot axis of the shifter lever in a first direction and the first end of the second core is operatively connected to the shifter lever so that the second core is pulled by the shifter lever when the shifter lever is pivoted about the pivot axis of the shifter lever in a second direction opposite the first direction;
wherein the first end of the first conduit is secured to the rearward end of the base so that the first core forwardly extends from the rearward end of the base to a first attachment location on the shifter lever, the first end of the second conduit is secured to the rearward end of the base so that the second core forwardly extends from the rearward end of the base to a second attachment location of the shifter lever, and the pivot axis of the shifter lever is located between the first attachment location and the second attachment location; and
a retention mount securing both the first end of the first conduit and the first end of the second conduit to the rearward end of the base; and
wherein the second end of the first core is secured to an actuated lever pivotable about a pivot axis so that the first core pivots the actuated lever about the pivot axis of the actuated lever in a first direction when the shifter lever pulls the first core and the second end of the second core is operatively connected to the actuated lever so that the second core pivots the actuated lever about the pivot axis of the actuated lever in a second direction opposite the first direction when the shifter lever pulls the second core.

18. A shifter assembly and control cable assembly for a motor vehicle comprising, in combination:
a shifter assembly comprising:
a base having a rearward end and a forward end opposite the rearward end;
a shifter lever pivotably connected to the base so that the shifter lever is pivotable over a shift path about a laterally extending pivot axis;
a shifter control cable assembly comprising:
a first conduit having a first end and a second end;
a first core disposed in the first conduit for longitudinal movement therein and having a first end and a second end;
a second conduit having a first end and a second end;
a second core disposed in the second conduit for longitudinal movement therein and having a first end and a second end;
wherein a first end of the first core is operatively connected to the shifter lever so that the first core is pulled by the shifter lever when the shifter lever is pivoted about the pivot axis of the shifter lever in a first direction and the first end of the second core is operatively connected to the shifter lever so that the second core is pulled by the shifter lever when the shifter lever is pivoted about the pivot axis of the shifter lever in a second direction opposite the first direction;
wherein the first end of the first conduit is secured to the rearward end of the base so that the first core forwardly extends from the rearward end of the base to the shifter lever, and the first end of the second conduit is secured to the forward end of the base opposite the rearward end of the base so that the second core rearwardly extends from the forward end of the base to the shifter lever;
wherein the first end of the first core and the first end of the second core are secured to a common attachment location of the shifter lever; and
wherein the second end of the first core is secured to an actuated lever pivotable about a pivot axis so that the first core pivots the actuated lever about the pivot axis of the actuated lever in a first direction when the shifter lever pulls the first core and the second end of the second core is operatively connected to the actuated lever so that the second core pivots the actuated lever about the pivot axis of the actuated lever in a second direction opposite the first direction when the shifter lever pulls the second core.

19. A shifter assembly and control cable assembly for a motor vehicle comprising, in combination:
a shifter assembly comprising:
a base;
a shifter lever pivotably connected to the base so that the shifter lever is pivotable over a shift path about a laterally extending pivot axis;
a shifter control cable assembly comprising:
a first conduit;
a first core disposed in the first conduit for longitudinal movement therein and having a first end and a second end;
a second conduit;
a second core disposed in the second conduit for longitudinal movement therein and having a first end and a second end;
wherein the first end of the first core is operatively connected to the shifter lever so that the first core is pulled by the shifter lever when the shifter lever is pivoted about the pivot axis of the shifter lever in a first direction and the first end of the second core is operatively connected to the shifter lever so that the second core is pulled by the shifter lever when the shifter lever is pivoted about the pivot axis of the shifter lever in a second direction opposite the first direction;
wherein the first core and the second core are operatively connected to the shifter lever by a double rack and pinion mechanism.
wherein the first end of the first core is secured to a first rack which is operably connected to the shifter lever, the first end of the second core is secured to a second rack, a pinion is rotatably supported by the base in a fixed position and operably engages each of the racks so that the first rack and the first core secured thereto is pulled by the shifter lever when the shifter lever is pivoted about the pivot axis of the shifter lever in a first direction and so that the first rack is pushed to rotate the pinion and pull the second rack and the second core secured thereto when the shifter lever is pivoted about the pivot axis of the shifter lever in a second direction opposite the first direction; and
wherein the second end of the first core is secured to an actuated lever pivotable about a pivot axis so that the first core pivots the actuated lever about the pivot axis of the actuated lever in a first direction when the shifter lever pulls the first core and the second end of the second core is operatively connected to the actuated lever so that the second core pivots the actuated lever about the pivot axis of the actuated lever in a second direction opposite the first direction when the shifter lever pulls the second core.
